(19) United States
(12) Patent Application Publication
(10) Pub. No.: US 2004/0040169 A1
(43) Pub. Date: Mar. 4, 2004

(54) Power tool alignment device

(76) Inventor: Richard LeRoy Davis, Murrells Inlet, SC (US)

Correspondence Address: KATHLEEN M HARLESTON, THE HARLESTON LAW FIRM, 909 TALL PINE ROAD, MT PLEASANT, SC, 29464

(21) Appl. No.: 10/233,920

(22) Filed: Sep. 3, 2002

(51) Int. Cl. B23Q 17/22

(52) U.S. Cl. 33/640

(57) ABSTRACT

An alignment device (10) for use in aligning a power tool blade or bit or a metal frame, includes:

a) a generally rectangular-shaped body (26), the body (26) having thereon two opposite, substantially parallel and planar side surfaces (20, 22), substantially parallel and planar opposite top and bottom surfaces (14, 16), the top and bottom surfaces (14, 16) being positioned at substantially right angles to the side surfaces (20, 22), substantially planar rear and front surfaces (18, 12), the top and bottom surfaces (14, 16) and side surfaces (20, 22) being positioned at substantially right angles to four edges, respectively, of the rear surface (18), the front surface (12) being angled;

b) at least two contact posts (36, 38) on the front or rear surface;

c) a power source (50) within the device, the contact posts (36, 38) being connected to the power source; and

d) a light source (46, 48) or sound source (49) connected with the power source (50);

wherein the light source lights up or the sound source sounds when the contact posts (36, 38) contact a metal surface.

### BACKGROUND OF THE INVENTION

1. Technical Field

The present invention relates to a portable, lightweight, inexpensive device for aligning a power tool, in particular, a device for indicating the angle of a saw blade, drill bit, or the like in order to make a particular angled or straight cut.

2. Background Information

There are many different types of commercially available angle indicators, protractor devices, miter degree apparatus, and gauges for use in a workshop, on a construction site, etc. In general, these available devices display often faint degree indicator lines or marks that a user must line up with other lines, or some type of a pointer, to measure an angle. Therefore, the user often must alter the angle slightly and do another reading in order to eventually achieve the desired degree angle of the object. Some devices even employ laser beams for aligning an object to a desired degree angle.

Unfortunately, most of these devices are rather difficult to use. First, many of them are either held in place by magnets or have to be clamped into position in order to use them.

Secondly, most of these devices must be placed in an exact location and on a level surface to be effective. A person desiring to set a saw blade at a given miter angle using a table saw's or radial arm saw's built-in miter indicator scale normally has to bend, kneel, squat, sit or lean across the saw in order to clearly observe the degree indicator lines on the miter scale.

Thirdly, a pointer is frequently employed on these saws to align with the degree lines on the miter scale; however, the pointers are often times much wider than the lines on the scale, making it difficult to determine the exact degree desired. Usually, time is wasted cutting pieces of scrap wood in order to determine whether the saw blade or drill bit is in the desired position.

Fourth, if a built-in miter indicator is not used on these types of saws, a handheld type angle indicator, bevel device, miter scale apparatus, or another type of inclinator or protector is most likely used. Unfortunately, the degree scale or degree lines on these are very small, fine, and close together. A person must have good eyesight, and a steady hand to accurately set the measuring instrument, and be in a well lit area or have a separate light shining on the measurement instrument.

Fifth, while using the power tool, if light can be seen between the alignment device and the saw blade or drill bit, the saw blade (or drill bit) must be readjusted. Again, the operator must bend, kneel, squat, sit or lean across the saw to align the saw blade (or drill bit) with the measuring instrument. The operator must also have relatively good eyesight and be in a well lit area to accomplish this task and even then, the operator will often find it necessary to run a piece of scrap wood through the saw to ensure that the saw blade is in the desired position. These procedures are time consuming, labor intensive, and require patience to achieve.

Laser beam aligning devices are often not practical to use, nor are they designed for use in very close quarters, such as in aligning a saw blade, skill saw, or drill press drilling platform. Instead, the majority of laser beam devices are suitable for use in leveling walls, cabinets, joists and rafters, etc.

These and other problems are solved by the present invention. To use the device for aligning a saw blade for a miter cut, the present alignment device is placed on top of the saw table top or platform with the 45°, 90°, etc., angle of the device placed against the saw blade, depending on the end of the device used. There is no need to cut scrap wood to double check the measurement. The present device can be used by older people without good eyesight or a steady hand, even in a dimly lit room. With the simple, user-friendly device of the present invention, it is not necessary to have a level surface to accurately set the saw blade. Bending, kneeling, squatting, sitting, and leaning across the saw table to set the saw blade, or drill bit, at the desired angle are unnecessary. The blade angle measuring device of the present invention has been found to be as accurate or more accurate than commonly available angle indicators, bevel devices, miter scale apparatus, etc., and much easier to use.

The blade angle indicator device of the present invention is lightweight and inexpensive and comes in a variety of sizes, depending upon the desired application. This device replaces several other types of woodworking tools, including levels, straight edges, and alignment devices in the shop or on the job site. This means fewer tools a person has to carry around. The saw blade angle indicator device is battery-operated. There are no switches to forget to turn off, thereby extending the life of the device's light emitting diode (LED) or light bulb and battery and/or buzzer. Furthermore, there are no complicated electronics in this device and there is only one moving part, which helps make the device durable against falls, hits, dampness, heat, sawdust, and dirt.

The indicator device of the present invention allows a hobbyist, professional wood worker, construction worker or anyone desiring to set an angle on a wide variety of power saws, drill presses, or anything metal or other material that is electrically conductive to do so easily and accurately.

### BRIEF SUMMARY OF THE INVENTION

The present invention is an alignment device for use in aligning a power tool blade or bit, such as a rotatable saw blade, reciprocating saw blade, band saw blade, radial arm saw blade, jig saw blade, scroll saw blade, skill saw blade, or drill bit, or a metal frame. The device includes:

a) a generally rectangular-shaped body, the body having thereon two opposite, substantially parallel and planar side surfaces, substantially parallel and planar opposite top and bottom surfaces, the top and bottom surfaces being positioned at substantially right angles to the side surfaces, substantially planar rear and front surfaces, the top and bottom surfaces and side surfaces being positioned at substantially right angles to four edges, respectively, of the rear surface, the front surface being angled;

b) at least two contact posts on the front or rear surface;

c) a power source within the device, the contact posts being connected to the power source; and

d) a light source or sound source connected to the power source;

wherein the light source lights up or the sound source sounds when the contact posts contact a metal surface.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 shows a perspective view of a blade alignment device according to the present invention;

FIG. 2 is a side elevational view of a blade alignment device according to the present invention;

FIG. 3 is a perspective view of the blade alignment device according to FIG. 1, shown in use against a power saw blade;

FIG. 4 is a perspective view of a blade alignment device according to the present invention, shown in use against a power saw blade;

FIG. 5 is a perspective view of the blade alignment device according to FIG. 1, shown in use on a power saw;

FIG. 6 is a perspective view of a blade alignment device according to the present invention, shown in use against a power saw blade;

FIG. 7 is a perspective view of the blade alignment device according to FIG. 1, shown in use on wall beams;

FIG. 8 is a side elevational view of an alternate embodiment of a blade alignment device according to the present invention;

FIG. 9 is a top plan view of the blade alignment device according to FIG. 8;

FIG. 10 is a bottom plan view of the blade alignment device according to FIG. 8;

FIG. 11 is a side, schematic view of an alternate embodiment of a blade alignment device, showing a front adjustable degree angle indicator portion;

FIG. 12 is a side elevational view of a blade alignment device according to the present invention, with a rear adjustable degree angle indicator portion in an open position;

FIG. 13 is a perspective view of the adjustable degree angle indicator portion of the blade alignment device according to FIG. 12; and

FIG. 14 shows a perspective view of an alternate embodiment of a blade alignment device according to the present invention, shown without rails.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

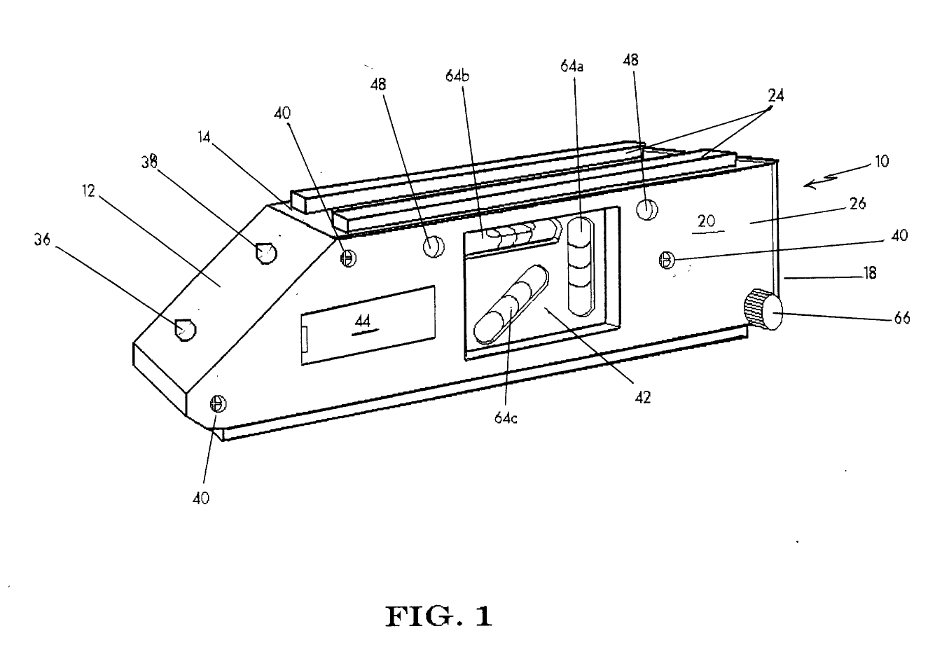

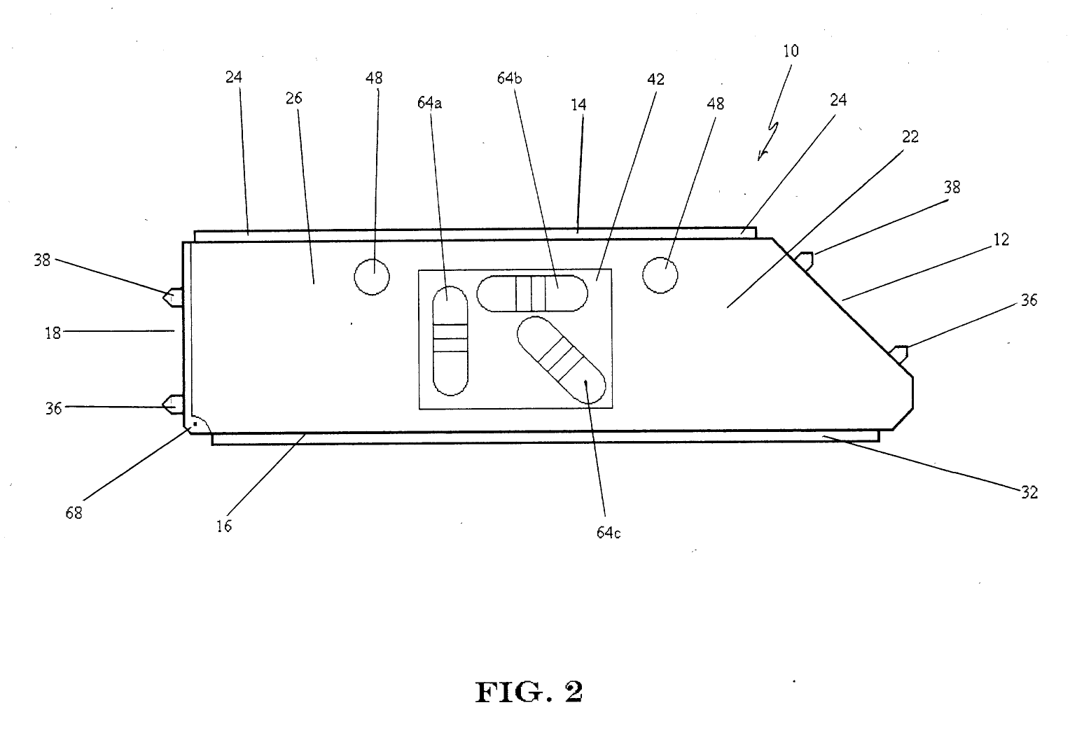

Turning first to FIGS. 1 and 2, a first embodiment of a power tool alignment device, generally referred to as 10, according to the present invention is for indicating the angle of a blade of a power rotatable saw, reciprocating saw, band saw, radial arm saw, jig saw, scroll saw, skill saw, drill bit, metal framing, or the like. The alignment device 10, which is also called an indicator device herein, generally has a substantially rectangular, block shaped body 26, but with an angled front nose surface 12. The nose surface 12 preferably slopes in a downward direction at a 45 degree angle, as shown in FIGS. 1 and 2. The body 26 of the indicator device 10 is substantially enclosed by an indicator device housing. The body 26 has thereon two opposite, substantially parallel and planar side surfaces 20, 22, substantially parallel and planar opposite top and bottom surfaces 14, 16, and substantially planar rear and front surfaces 18, 12. The top and bottom surfaces 14, 16 and side surfaces 20, 22 are positioned at substantially right angles to four edges, respectively, of the rear surface 18. The front, nose surface 12 is angled, preferably a 45 degree angle. The top and bottom surfaces 14, 16 are positioned at substantially right angles to the side surfaces 20, 22. Although the top surface 14, opposite bottom surface 16, rear surface 18 opposite the nose surface 12, and two opposite side surfaces 20, 22 are substantially planar, two upper rails 24 preferably extend from or are attached to the top surface 14. Though they are called “top” and “bottom” surfaces herein, the top surface can act as the bottom surface and vice versa, depending on how the user positions the device 10 on the table or other surface. The device 10 is usable for its various purposes in any position.

The indicator device 10 can be made of any suitable material, preferably durable plastic, or aluminum or other metal. The device 10 is portable, lightweight, easy to use, and durable, which is important in the environment in which it is used. In this preferred embodiment, two upper rails 24 are equal in length and parallel to one another, and extend along the longitudinal axis of the device 10.

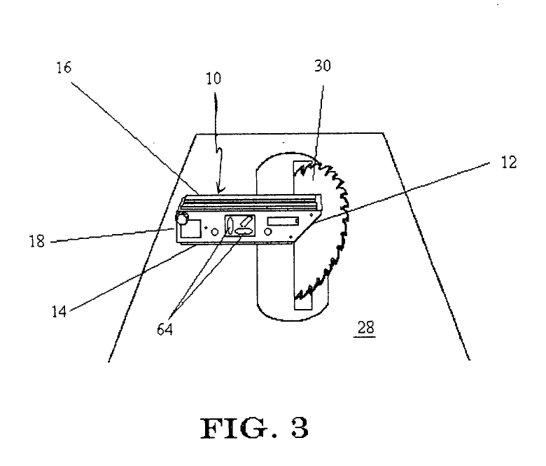

Referring to FIGS. 3 through 5, to use the saw blade angle indicator device 10 for aligning a saw blade for a miter cut, for example, the indicator device 10 is placed on top of the platform or saw table 28, with the 45°, 90°, etc., angle, depending on the end of the device 10 that is pushed, against the saw blade 30. The indicator device 10 may be used right side up, as shown in FIGS. 1 and 2, so that the bottom surface 16 lies against the saw blade table top 28, or upside down, as shown in FIGS. 3 through 5, so that the top surface 14 lies on the saw blade table 28.

As shown in FIG. 3, lower rails 32 are attached to the bottom surface for supporting the device 10 on a table top. In this embodiment, the lower rails 32 are equal in length and parallel to one another, and extend along the longitudinal axis of the device 10. Since the device housing may be made in two longitudinal sections that are seamed together, the seam or other imperfections in the housing may cause the alignment device 10 to rock or wobble from side to side, which disrupts the alignment process. The upper or lower rails 24, 32, depending on which surface of the device is placed on the saw table, ensure that the device 10 remains stable (i.e., does not rock or wobble). Also, the upper and/or lower rails can be magnetic, so that they are magnetically attracted to a metallic surface, such as metal framing or the like. This further ensures stability of the device 10, which translates to an easier-to-use/more accurate device.

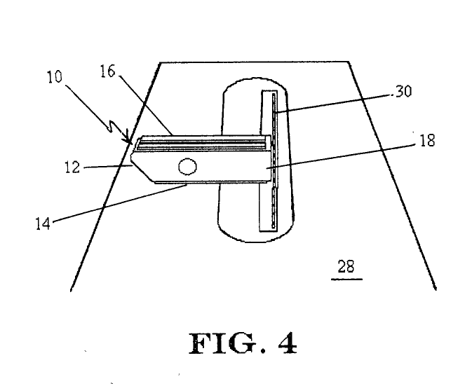

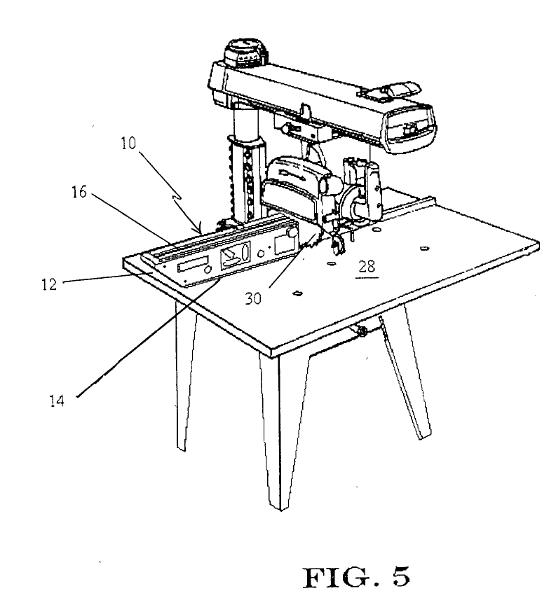

Continuing with FIGS. 3-5, the same indicator device 10 can be used with its nose surface 12 against the saw blade 30, as shown in FIG. 3, or it can be used in reverse, so that the rear surface 18 is positioned against the saw blade 30, as shown in FIGS. 4 and 5. The front nose surface 12 places the saw blade 30 at a 45 degree angle with reference to the table top 28, and the substantially planar rear surface 18 pushes against the saw blade 30 at a 90 degree, or right, angle. FIGS. 3 and 4 show opposite ends of the indicator device 10 in place against a saw blade 30, and FIG. 5 shows an indicator device 10 on a saw table 28, with its rear surface 18 against the saw blade 30. For purposes of illustration, FIG. 5 shows an overly large device 10.

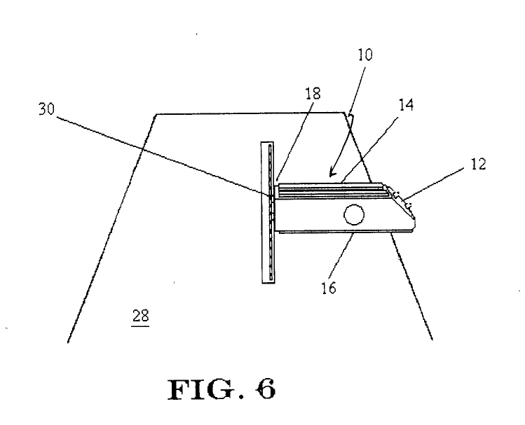

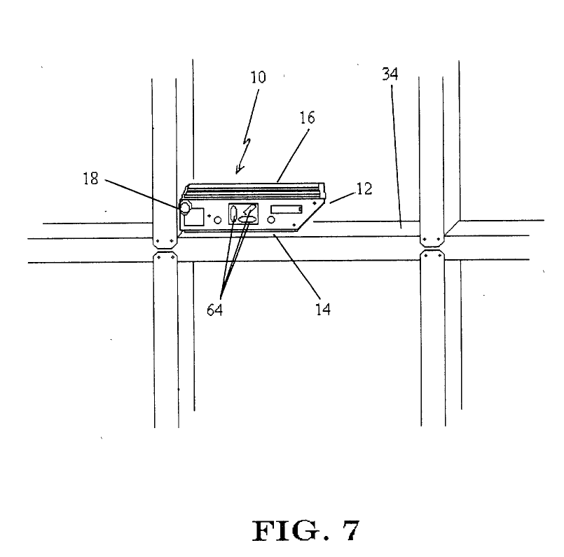

Referring to FIGS. 6 and 7, FIG. 6 shows a saw blade indicator device 10 in use on an opposite side of a saw blade 30, with its bottom surface 16 resting on the table top 28 and its rear surface 18 against the saw blade 30. FIG. 7 shows how the versatile alignment device 10 can be used for leveling metal or wood ceiling or wall beams 34. Although the alignment device 10 is shown with its top surface 14 resting on a wall beam 34, it can be used in the same manner with its bottom surface 16 resting on the wall beam 34. The alignment device 10 can also be used for indicating the angle of metal or wood framing, e.g., on a construction site.

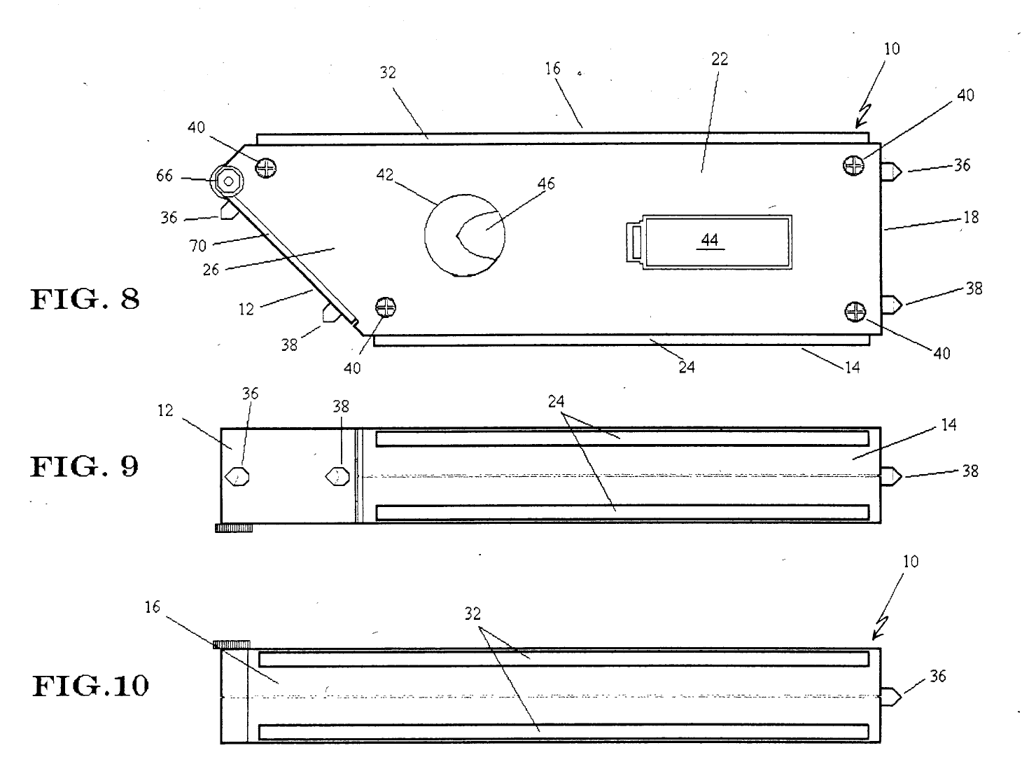

Referring to the alternate embodiment shown in FIGS. 8 to 10, and the first embodiment shown in FIGS. 1 and 2, the indicator device 10 further comprises contact posts on the front (nose) and rear surfaces 12, 18. In these preferred embodiments, positive and negative contact posts 36, 38 are aligned on each end surface 12, 18 substantially parallel to one another, and substantially perpendicular to the front or rear surface. No clumsy clamping of the indicator device to the saw blade is necessary. The top (FIG. 9) and bottom (FIG. 10) views of the second device 10 show upper and lower rails 24, 32.

Continuing with FIGS. 1 and 2, and FIGS. 8 to 10, the indicator housing is removably attached to the outside of the body 26 of the device 10 by recessed housing screws 40. The device housing includes a cut-out for a window box 42, which is rectangular-shaped in the first embodiment, per FIGS. 1 and 2, and circular in shape in the second embodiment of FIGS. 8-10. An incandescent light bulb 46 is visible through a lens in the window box 42 of the second embodiment shown in FIG. 8. The window need not include a lens. The light bulb 46 or the lens can be colored if desired, or a white light can be used. In the first embodiment of FIGS. 1 and 2, at least one light emitting diode 48 (LED) is visible on the device 10, preferably several LEDs along each side 20, 22. As shown in FIGS. 1 and 8, each of the devices 10 includes a battery door 44 in a side surface 20, 22.

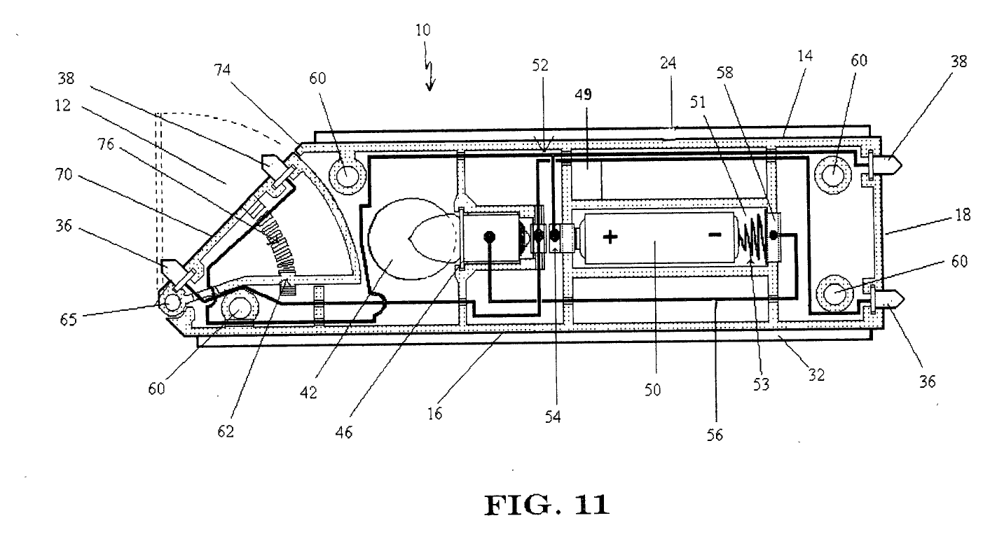

Referring to FIG. 11, which illustrates the inside of a preferred embodiment of the device 10, the battery door allows access to a battery 50 in a battery holder 51, or housing, in the interior of the device. The battery 50, which is most preferably a 1.5 volt AA battery, is held via a spring 53 in the battery holder 51. The front and rear contact posts 36, 38 are connected by lead wires to the battery. As shown in FIG. 11, at least one positive wire 52 connects the two opposite contact posts 38 to a positive connector 54. At least one negative wire 56 connects the negative contact posts 36 to the negative end 58 of the battery 50.

When the positive and negative contact posts 36, 38 on one end surface of the device 10 come in contact with the metal blade 30 or object, the electrical circuit is completed, which causes the light bulb 46 or LED 48 to light up. This signals to the user that the device 10 has been placed correctly, and the reading can be taken. If the device 10 is bumped or otherwise moves, contact is lost, which causes the light bulb 46 or LED 48 to go out. The user is then made aware that he or she must reposition the device against the blade. This provides quick, easily interpreted feedback to the user. This is true regardless which end surface, front nose 12 or rear 18, is placed against the blade 30. If the light/LED comes on when the flat rear surface 18 is against the saw blade 30 or drill bit, it indicates that the saw blade or drill bit is at a 90 degree angle relative to the saw table. If the light or LED comes on when the nose surface 12 is against the blade 30 or drill bit, it indicates that the blade/bit is at a 45 degree angle relative to the table. Several screw post holes 60 for receiving the housing screws 40 are also shown in FIG. 11.

Instead of, or in addition to, the light source lighting up when contact is made with the metal saw blade (or drill bit), the alignment device 10 may include a set of chimes, a buzzer element, or a music chip in its interior. When contact is made, the buzzer or chimes or the like sound to alert the user that contact has been made between the contact posts and the metal power tool surface. This provides an option for those users who are so hard at work that they do not have time to look at the LED(s) or light on the device. The cessation of the sound before the user has completed the measurement signals to the user that the connection has been broken and he or she should reset the device against the metal tool surface.

Lastly, in a preferred embodiment, as shown in FIGS. 1 and 2, one or more level vials 64 are included in the device 10 so that the device can also be used as a level, regardless of which way the device is laid on the surface. Three level vials 64 are visible in the window box 42 of the first embodiment of FIGS. 1 and 2, so they can be seen from both sides of the device 10. In addition to the primary function of the device as described herein, the device 10 can also be used to check the level of any suitable surface, such as a table or beam. A first level vial 64a is vertically positioned in the window box, with respect to the longitudinal axis of the device, for assessing verticality, a second level vial 64b is horizontally positioned in the window box (i.e., along the same longitudinal axis as the device) for assessing horizontality, and a third level vial 64c is positioned in the window box at a 45 degree angle for use in checking a 45 degree angle. A luminous fluid may be included in the level vials for improved visibility.

For example, a user can use the alignment device 10 for leveling studs on a wall, or to check a 45 degree angle by viewing the third level vial 64c. The user can, for example, place the device 10 at the intersecting point of a pair of perpendicular beams to make sure they are at right angles to one another, or the device 10 can be used to check the 45 degree angle of a cross-beam.

In an alternate embodiment, the contact posts 36, 38 are made of a material which is magnetically attracted to the metal of the saw blade 30, or other subject power tool part. Once the appropriate end of the device 10 is placed against the blade, the two magnetic posts 36, 38 hold the indicator device 10 in place while measurements are being taken. Since they maintain the present indicator device 10 in a stable position, they contribute to the accuracy of the device 10.

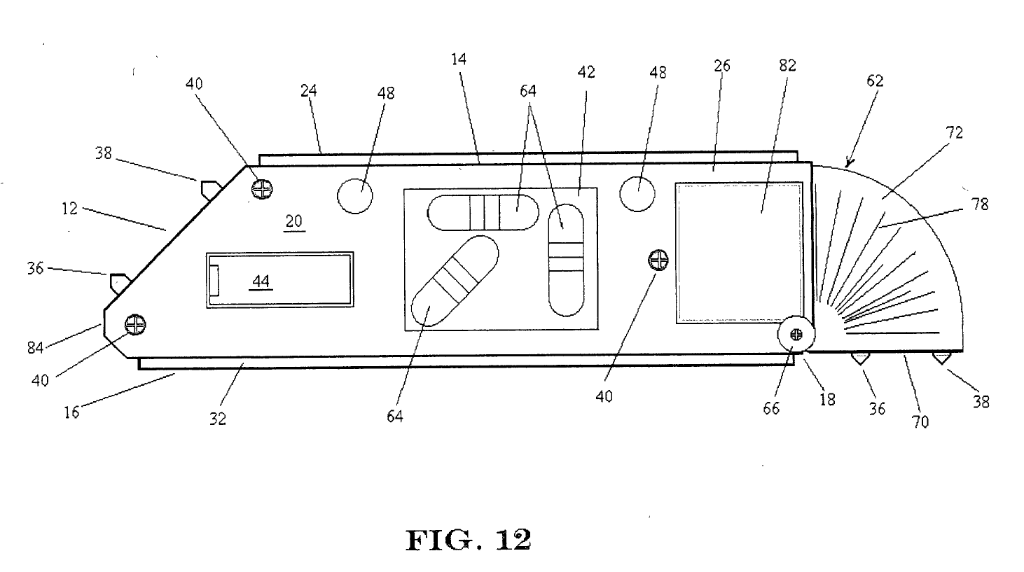

This third embodiment of FIG. 11 importantly differs from the first two embodiments described herein by the adjustable degree angle indicator portion 62 in the front portion of the device (see below). The embodiment of FIG. 11 shows the third embodiment, which has a light bulb rather than an LED, with the adjustable degree angle indicator portion 62 in the front, while FIGS. 12 and 13 show an embodiment with an adjustable degree angle indicator portion 62 in the rear of a device 10 with LEDs 48 and level vials 64. FIG. 11 also shows a buzzer element 49 in the interior of the device. The buzzer element, which could alternatively be chimes or a music chip, is also connected to the battery 50 and is activated during the time that the contact posts 36, 38 contact metal.

Continuing with FIGS. 11 to 13, the adjustable degree angle indicator portion 62 in the front (FIG. 11) or rear (FIGS. 12 and 13) portion of the alignment device 10 are utilized for cutting a less common angle, particularly angles other than 45° or 90°. The unique adjustable degree angle indicator portion 62 comprises a knurled locking knob 66, a hinged or pressure probe bar 74, an indicator door 70, and a wheel quadrant section 72. A lower portion of the wheel quadrant section 72 is affixed to an inside of the indicator door 70, so that the wheel quadrant section 72 moves when the indicator door 70 is opened by a user. The wheel quadrant section 72 does not interfere with the contact posts 36, 38 on the indicator door 70. The stem 68 of the knurled knob 66 (see FIG. 2) extends through a knurled knob hole 65 in the lower corner of the housing (see FIG. 11) at the front or rear of the device 10, and through a hole in the lower corner of the wheel quadrant section 72. The wheel quadrant section 72 is positioned between the two sides 20, 22 of the device and is rotatable on the knurled knob stem 68. When the indicator door 70 is closed, as shown in FIGS. 1, 11, and 14, the wheel quadrant section 72 is stored within the device 10. When the indicator door 70 is opened, as shown in FIGS. 12 and 13, the adjustable degree angle indicator portion 62 is ready for use. To use the adjustable degree angle indicator portion 62, the knurled locking knob 66 on the side of the saw blade alignment device is simply loosened, and the wheel quadrant section 72 is pulled out to the desired angle by pulling the indicator door 70 down.

A curved portion of the wheel quadrant section 72 includes spaced-apart indicator notches 76 which correspond to markings 78 on the side of the wheel quadrant section 72. Unlike commonly available alignment devices, every five degrees (5°) marked on the side of the wheel quadrant section 72 has a notch 76 associated with it. The markings 78 are preferably in one degree increments.

The somewhat flexible pressure probe bar 74, which can alternatively be hinged, is built into the rear of the top surface of the device 10. A tab 80 extends vertically down from the horizontally oriented pressure probe bar 74. When the indicator door 70 is pulled down by the user, the tab 80 at the end of the pressure probe bar 74 automatically snaps into and out of the notches 76, making a clicking, or tick-tick, sound. This sound assists the user in knowing when he or she has the wheeled quadrant section 72 in a desired position. When the particular desired degree is reached, the wheel quadrant section 72 is held in place while the locking knob 66 on the side of the device 10 is re-tightened. This will lock the wheel quadrant 72 securely into place. Next, the same procedure is conducted in order to align the saw blade. This procedure can be carried out in poorly lit areas and without having keen eyesight. There is no need to test cut scrap wood to ensure that the saw blade is in the desired angle position. Since each five degree increment is locked into a notch 76, there is no guesswork or estimation required.

The power tool alignment device 10 has small, thin lines between each 10° marking, with the exception of 22.5° and 45.5°. Both of these degrees have locking notches, just like every fifth and tenth degree mark on this device 10. Not having locking notches for each degree between every fifth and tenth degree mark is acceptable, since most wood working projects do not fall within these odd degree ranges. If an odd degree situation is required, the power tool alignment device 10 can still be used accurately because each degree from 45° to 90° is marked on the side of the wheel quadrant section 72.

Referring to FIG. 14, one or both side surfaces 20, 22 of the body 26 of the device may include an area for placement of a decal 82 (also see FIGS. 12 and 13). FIG. 14 shows an alternate embodiment of the alignment device 10 without upper or lower rails 24, 32. The pressure probe bar 74 is shown on the top surface 14 of the device, with the indicator door 70 and knurled knob 66 of the adjustable degree angle indicator portion 62 shown in the rear portion of the device 10. The lower front corner 84 of the nose surface 12 of the devices is preferably blunted to avoid contact with the saw blade or drill bit and avoid scratching the user (also see FIG. 12).

In summary, then, the alignment device 10 comprises:

a) a generally rectangular-shaped body 26, the body 26 having thereon two opposite, substantially parallel and planar side surfaces 20, 22, substantially parallel and planar opposite top and bottom surfaces 14, 16, the top and bottom surfaces 14, 16 being positioned at substantially right angles to the side surfaces 20, 22, substantially planar rear and front surfaces 18, 12, the top and bottom surfaces 14, 16 and side surfaces 20, 22 being positioned at substantially right angles to four edges, respectively, of the rear surface 18, the front surface 12 being angled;

b) at least two contact posts 36, 38 on the front or rear surface, the contact posts 36, 38 being in a circuit with a power source 50 within the device 10; and

c) a light or sound source connected with the power source 50;

wherein the light source 46, 48 lights up, and/or the sound source 49 emits a sound, when the contact posts 36, 38 contact a metal surface.

In preferred embodiments of the alignment device 10:

(1) the front surface is at a 45 degree angle with respect to the side surfaces.

(2) the light source is at least one light bulb 46 or light emitting diode 48 electrically connected in circuit with the power source.

(3) the power source is a battery 50, the device further comprising a battery holder 51 in its interior for holding the battery 50, the battery holder 51 having a battery door 44 in a side surface 20, 22 of the device.

(4) the sound source 49 is a buzzer or chime connected to the battery 50.

(5) the device 10 further comprises a window box 42 within the two side surfaces, the single incandescent light bulb 46 being set into the window box 42, the light bulb 46 being connected to the battery 50, so that the light is visible from both sides of the device 10.

(6) the device further comprising at least one level vial 64 positioned within the window box 42, so that it is visible from both sides of the device 10.

(7) the front surface and rear surface each comprises a set of two of the contact posts, at least one of the contact posts being connectable to a negative end of the battery, at least one of the contact posts being connectable to a positive end of the battery, the battery being connected to the light bulb or LED; wherein the light bulb or LED lights up when the positive and negative contact posts contact the metal surface of the power tool blade or bit.

(8) the positive and negative contact posts 36, 38 are aligned on each end surface 12, 14 substantially parallel to one another, and substantially perpendicular to the front or rear surface, respectively.

(9) the contact posts 36, 38 can be magnetic.

(10) the device 10 further includes at least two matching rails 24, 32 extending along the longitudinal axis of the top or bottom surface of the device.

(11) the rails 24, 32 are magnetic.

(12) there are two sets of matching rails, one set of rails 24 being affixed to the top surface and one set 32 being affixed to the bottom surface, the rails in each set being substantially equal in length and generally parallel to one another.

(13) the device further includes an adjustable degree angle indicator portion 62 in the front or rear of the device 10.

(14) the adjustable degree angle indicator portion comprises a knurled locking knob 66, a hinged or pressure probe bar 74, an indicator door 70, and a wheel quadrant section 72, a stem 68 of the knurled knob 66 extending through a hole 65 in the side surfaces and through a portion of the wheel quadrant section 72, the wheel quadrant section 72 being positioned between the two side surfaces and being rotatable on the knurled knob stem 68.

(15) a lower portion of the wheel quadrant section 72 is affixed to an inside of the indicator door 70; and, when the indicator door 70 is closed, the wheel quadrant section 72 is stored within the device 10, and, when the indicator door 70 is opened, the adjustable degree angle indicator portion 62 is ready for use.

(16) the wheel quadrant section 72 comprises a curved portion having spaced-apart indicator notches 76 which correspond to scale markings 78 on the side of the wheel quadrant section 72.

(17) the top surface of the device 10 comprises the flexible pressure probe bar 74, a tab 80 extending vertically down from the horizontally oriented pressure probe bar 74; and, when the indicator door 70 is opened, the tab 80 automatically snaps into and out of the notches 76.

Also included in the present invention is a method of aligning a saw blade or drill bit using the alignment device as described hereinabove.

Thus, the device of the present invention may be with or without rails (magnetic or not), buzzers, chimes, adjustable degree angle indicator portion, level vials, contact probes, or any combination thereof. It may include incandescent light bulbs or LED(s).

The power tool alignment device 10 is not for guiding a saw blade or drill bit while it cuts; it is for aligning the blade or drill bit at a precise desired angle. The basic alignment device 10 preferably does not include a protractor and is not simply acting as a straight edge, though it includes a handy straight (longitudinal top or bottom side) edge if one is needed for side tasks. The present alignment device is preferably not channel-shaped or L-shaped, and preferably does not comprise a laser. With the exception of the optional adjustable degree angle indicator portion 62, there are preferably no moving parts on the alignment device 10. The present alignment device 10 can be carried from power tool to power tool. It does not require attachment, and is preferably not attached, to the table saw or other power tool.

Since the preferred embodiments herein incorporate several tools in one, they can replace a level, ruler, square, as well as other tools or methods of alignment in a workshop or on a job site. Most preferably, an alignment device herein is between about eight and 12 inches in length (at its longest point), about two and five inches in width, and about ½ and three inches in thickness, in order to accommodate most saw blades.

When the alignment device 10 is used, hard to reach or hard to see compound miter saw miter indicators, which are often at the back of the saw, are no longer a problem. This is particularly helpful for older, farsighted users.

From the foregoing it can be realized that the described device of the present invention may be easily and conveniently utilized to indicate the angle of a rotatable saw blade or drill bit. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. An alignment device for use in aligning a power tool blade or bit or a metal frame, the device comprising:
a) a generally rectangular-shaped body, the body having thereon two opposite, substantially parallel and planar side surfaces, substantially parallel and planar opposite top and bottom surfaces, the top and bottom surfaces being positioned at substantially right angles to the side surfaces, substantially planar rear and front surfaces, the top and bottom surfaces and side surfaces being positioned at substantially right angles to four edges, respectively, of the rear surface, the front surface being angled;
b) at least two contact posts on the front or rear surface;
c) a power source within the device, the contact posts being connected to the power source; and
d) a light source or sound source connected to the power source;
wherein the light source lights up or the sound source sounds when the contact posts contact a metal surface.

2. An alignment device according to claim 1, wherein the front surface is at a 45 degree angle with respect to the side surfaces.

3. An alignment device according to claim 2, wherein the light source is at least one light bulb or light emitting diode electrically connected to the power source.

4. An alignment device according to claim 3, wherein the power source is a battery, the device further comprising a battery holder in its interior for holding the battery, the battery holder having a battery door in a side surface of the device.

5. An alignment device according to claim 4, wherein the sound source is a buzzer or chime connected to the battery.

6. An alignment device according to claim 5, further comprising a window box set within the two side surfaces, wherein a single, incandescent one of the light bulbs is set into the window box, the light bulb being connected to the battery.

7. An alignment device according to claim 1, further comprising at least one level vial.

8. An alignment device according to claim 6, further comprising three level vials positioned within the window box, a first level vial being vertically positioned in the window box for assessing verticality, a second level vial being horizontally positioned in the window box for assessing horizontally, and a third level vial being positioned in the window box at a 45 degree angle.

9. An alignment device according to claim 4, wherein the front surface and rear surface each comprises a set of two of the contact posts.

10. An alignment device according to claim 9, wherein at least one of the contact posts is connectable to a negative end of the battery, at least one of the contact posts is connectable to a positive end of the battery, the battery being connected to the light bulb or light emitting diode; wherein the light bulb or light emitting diode lights up when the positive and negative contact posts contact the metal surface of the power tool blade or bit.

11. An alignment device according to claim 10, wherein the positive and negative contact posts are aligned on each surface substantially parallel to one another, and substantially perpendicular to the front or rear surface, respectively.

12. An alignment device according to claim 11, wherein the contact posts are magnetic.

13. An alignment device according to claim 4, further comprising at least two matching rails extending along the longitudinal axis of the top or bottom surface of the device.

14. An alignment device according to claim 13, wherein the rails are magnetic.

15. An alignment device according to claim 13, wherein there are two sets of matching rails, one set of rails being affixed to the top surface and one set being affixed to the bottom surface, the rails in each set being substantially equal in length and generally parallel to one another.

16. An alignment device according to claim 1, further comprising an adjustable degree angle indicator portion in the front or rear of the device.

17. An alignment device according to claim 4, wherein the adjustable degree angle indicator portion comprises a knurled locking knob, a hinged or pressure probe bar, an indicator door, and a wheel quadrant section, a stem of the knurled knob extending through a hole in the side surfaces and through a portion of the wheel quadrant section, the wheel quadrant section being positioned between the two side surfaces and being rotatable on the knurled knob stem.

18. An alignment device according to claim 17, wherein a lower portion of the wheel quadrant section is affixed to an inside of the indicator door; and wherein, when the indicator door is closed, the wheel quadrant section is stored within the device, and, when the indicator door is opened, the adjustable degree angle indicator portion is ready for use.

19. An alignment device according to claim 17, wherein the wheel quadrant section comprises a curved portion having spaced-apart indicator notches which correspond to scale markings on the side of the wheel quadrant section.

20. An alignment device according to claim 17, wherein the top surface of the device comprises the flexible pressure probe bar, a tab extending vertically down from the horizontally oriented pressure probe bar; and wherein, when the indicator door is opened, the tab automatically snaps into and out of the notches.
